(19) United States
(12) Patent Application Publication
(10) Pub. No.: US 2025/0242713 A1
(43) Pub. Date: Jul. 31, 2025

(54) STARTUP CONDITION MONITORING SYSTEM FOR A MACHINE

(71) Applicant: CATERPILLAR INC., Peoria, IL (US)

(72) Inventors: Yanchai ZHANG, Dunlap, IL (US); Shiferaw Damtie BEYENE, Peoria, IL (US); Yifeng LU, Chicago, IL (US); Zhaoxu DONG, Dunlap, IL (US); Kyle B. WALTON, Edelstein, IL (US); Jon B. BORGESON, Washington, IL (US); Kenneth E. WARNING, Brimfield, IL (US)

(73) Assignee: CATERPILLAR INC., Peoria, IL (US)

(21) Appl. No.: 18/423,571

(22) Filed: Jan. 26, 2024

(51) Int. Cl. B60L 53/80; B60L 58/16

(52) U.S. Cl. CPC B60L 53/80; B60L 58/16

(57) ABSTRACT

A startup condition monitoring device may have a sensor module for detecting at least one control parameter of a machine. The device may have a data acquisition unit communicatively coupled to the sensor module, the data acquisition unit being configured to receive the at least one control parameter from the sensor module, store the at least one control parameter, and transmit the at least one control parameter to a processor communicatively coupled to the data acquisition unit. The processor may be configured to: determine a performance standard for the machine using a physics-based model and historical data; adjust the performance standard using a machine learning model and additional historical data to account for at least one variation; generate at least one calculated parameter based on the adjusted performance standard; and display a startup health indicating at least one startup condition based on the determined at least one calculated parameter.

### TECHNICAL FIELD

The present disclosure relates generally to a monitoring system for a machine, and more particularly, to a startup condition monitoring system for a machine.

### BACKGROUND

Extant solutions for monitoring of startup conditions in a machine or genset generally require additional current sensors and voltage sensors. Such additional sensors are used to monitor the startup condition for a battery, an alternator, and/or a starter of the machine or genset. These additional sensors are individually installed in or near each component being monitored (e.g., the battery, alternator, and/or starter), each additional sensor being used to monitor various parameters of each component by sensing, e.g., voltage, current, revolutions, temperature, and other parameters and relaying the sensed data to a processor or user to indicate a startup condition of the machine and/or each component of the machine. Such sensors, therefore, add an extra cost to the system.

U.S. Pat. No. 9,784,798 B2 to Hirschbold et al. (“the '798 patent”) that issued on Oct. 10, 2017, discloses a system for determining the state of health of a generator battery set. The '798 patent discloses capturing the battery voltage profile during generator start-up and tracking the voltage profile over time. The '798 patent further discloses that a digital power meter may monitor and record the voltage across terminals of the battery during a generator starting operation to assess the health of the battery and/or generator and/or battery/generator system including the generator, battery, starter motor, and other ancillary components. Further, the '798 patent discloses that the battery voltage profile features can be used to build a reference voltage profile for generator starts, and future battery voltage profiles captured during generator starts can be compared against this reference voltage profile to determine if there has been a deterioration in the performance of the battery and/or generator starter motor and/or generator and/or associated ancillary equipment.

Although the '798 patent discloses determining the state of health of a generator battery set, the disclosed systems and methods may still not be optimal. In particular, the systems and methods of the '798 patent rely on a digital power meter which is used to capture a battery voltage profile, thereby requiring at least one additional sensor. Furthermore, the systems and methods of the '798 patent rely solely on the battery voltage profile in determining the state of health of a generator set.

Thus, there is a need for a device, system, or method for monitoring parameters such as the health of a starter, alternator, battery, and/or other components of the machine or genset without requiring additional sensors to determine an overall startup health or condition of the machine or genset. Furthermore, extant solutions fail to account for variations in, e.g., systems, equipment, components, temperature, or geographic location when determining the health of the overall system or a component thereof. As a result, the determination of the health of the overall system or components thereof is less trustworthy. Such lack of accuracy is undesirable and may be critical for certain high-risk applications such as machines or gensets used for hospitals, banks, and other locations where one has to be certain that the machine or genset will power up when required.

The systems, methods, and devices of the present disclosure solve one or more of the problems set forth above and/or other problems of the prior art.

### SUMMARY

In one aspect, a startup condition monitoring device may include a sensor module configured to detect at least one control parameter of a machine. The startup condition monitoring device may also include a data acquisition unit communicatively coupled to the sensor module. The data acquisition unit may be configured to receive the at least one control parameter from the sensor module. The data acquisition unit may also be configured to store the at least one control parameter. Further, the data acquisition unit may be configured to transmit the at least one control parameter to a processor communicatively coupled to the data acquisition unit. The processor may be configured to determine a performance standard for the machine using a physics-based model and historical data. The processor may also be configured to adjust the determined performance standard using a machine learning model and additional historical data to account for at least one of systemic, equipment, environmental, or geographic variations. The processor may be configured to generate at least one calculated parameter for the machine based on the adjusted performance standard. In addition, the processor may be configured to display, via a user interface, a startup health indicating at least one startup condition of the machine based on the determined at least one calculated parameter.

In another aspect, the present disclosure is directed to a system. The system may include a sensor module configured to detect at least one control parameter of a machine. The system may also include a data acquisition unit communicatively coupled to the sensor module. The data acquisition unit may be configured to receive the at least one control parameter from the sensor module. The data acquisition unit may also be configured to store the at least one control parameter. Further, the data acquisition unit may be configured to transmit the at least one control parameter to at least one processor. The system may further include at least one memory storing instructions. The at least one processor may be configured to execute the instructions to perform operations. The operations may include determining a performance standard for the machine using a physics-based model and historical data. The operations may also include adjusting the determined performance standard using a machine learning model and additional historical data to account for at least one of systemic, equipment, environmental, or geographic variations. Further, the operations may include generating at least one calculated parameter for the machine based on the adjusted performance standard. The operations may also include displaying, via a user interface, a startup health indicating at least one startup condition of the machine based on the determined at least one calculated parameter.

In yet another aspect, the present disclosure is directed to a method for monitoring a startup condition of a machine. The method may include detecting at least one control parameter of a machine. The method may also include receiving, storing, and transmitting the at least one control parameter. Further, the method may include determining a performance standard for the machine using a physics-based model and historical data. The method may include adjusting the determined performance standard using a machine learning model and additional historical data to account for at least one of systemic, equipment, environmental, or geographic variations. The method may also include generating at least one calculated parameter for the machine based on the adjusted performance standard. Additionally, the method may include displaying, via a user interface, a startup health indicating at least one startup condition of the machine based on the determined at least one calculated parameter.

### BRIEF DESCRIPTION OF THE DRAWINGS

FIG. 1 is a block diagram of an exemplary disclosed system;

FIG. 2 is an illustration of an exemplary disclosed voltage trend;

FIG. 3 is another illustration of an exemplary disclosed voltage trend;

FIG. 4 is a flow chart of an exemplary disclosed process for determining calculated parameters based on collected control parameters of a machine;

FIG. 5 is an illustration of an exemplary disclosed minimum voltage trend chart;

FIG. 6 is an illustration of an exemplary disclosed user interface;

FIG. 7 is a flow chart of an exemplary disclosed high fidelity model;

FIG. 8 is a block diagram illustrating an exemplary operating environment including a machine learning model;

FIG. 9 is an illustration of exemplary disclosed test and simulation data;

FIG. 10 is a flow chart of an exemplary disclosed process for determining a health level of a machine component; and

FIG. 11 is a flow chart of an exemplary disclosed method for monitoring a startup condition of a machine.

### DETAILED DESCRIPTION

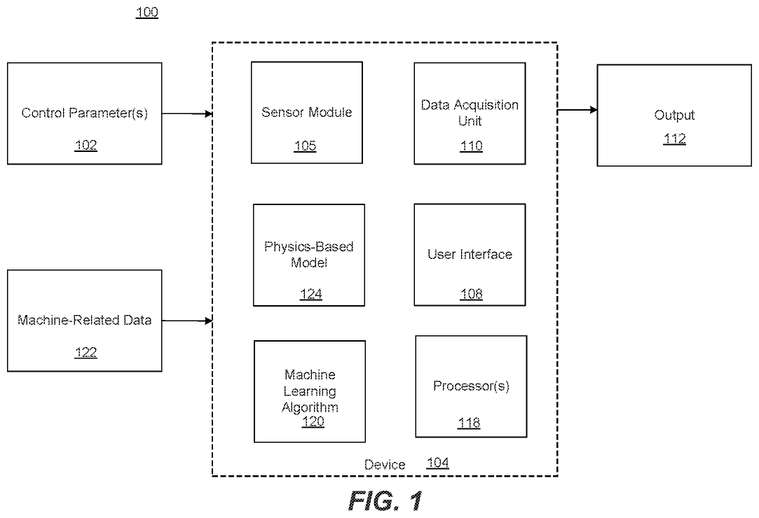

FIG. 1 illustrates an exemplary system 100 for startup condition monitoring. Startup condition monitoring may refer to determining, based on recorded or monitored parameters of various components of a machine, a state of health of the machine or a state of health of components thereof, such as a battery, alternator, and/or starter of the machine upon a startup event associated with the machine. Startup condition monitoring may also refer to guaranteeing a healthy future startup event based on a determined state of health of the machine or components thereof. System 100 may include device 104. In the depicted embodiment, a machine being monitored (not shown in FIG. 1) may be a generator. It is contemplated, however, that the machine may embody another type of machine which may include a generator or an engine, such as a wheel loader, an excavator, a shovel, a continuous miner, a loader, a truck, a track-type-tractor, a motor grader, an articulated haul truck, an off-highway mining truck, or another construction machine known in the art. The machine may be equipped with sensors which collect control parameters 102 and send control parameters 102 to sensor module 105. Control parameters 102 may thus be detected by device 104 via sensor module 105. Sensor module 105 may comprise hardware, software, a combination of hardware and software, or special purpose hardware. Sensor module 105 may include one or more sensors along with supporting components into a single unit, and may be designed to detect and measure one or more physical or environmental parameters associated with a machine and convert them into electrical signals for further processing or analysis.

Control parameters may refer to one or more performance metrics associated with an operation of the machine, including those which may be typically monitored. Control parameters may be sensed by various sensors located within the machine. These sensors may be provided in the originally manufactured machine rather than being additional sensors installed for operation of the device. Such sensors may collect control parameters including, e.g., machine voltage during or prior to a startup event (e.g., battery voltage, minimum voltage, step voltage, peak-to-peak voltage, pre-startup voltage, or another machine-related voltage), crank engine speed, startup duration of the machine, and machine temperature (e.g., coolant temperature, ambient temperature, or another machine-related temperature). A startup event may refer to a process of bringing the machine from an idle or off state to an operational state where the machine is producing electrical power or performing other machine operations. Step voltage may refer to an instantaneous change in voltage level. A step voltage may occur when the voltage output or potential difference across the terminals of a battery or generator changes from one value to another, potentially without any gradual transition. For example, in a battery, a step voltage might occur when the battery is suddenly connected to a load, causing the voltage across its terminals to drop due to the current flowing through the load. Conversely, when the load is disconnected, the voltage may rise to a higher level. Peak-to-peak voltage may refer to the difference between the highest positive voltage and the lowest negative voltage levels observed in an alternating current (AC) or time-varying electrical signal. Peak-to-peak voltage may be measured from the maximum positive peak to the minimum negative peak of the voltage waveform. In the case of a battery or generator producing an AC output, the voltage may fluctuate between positive and negative values, reaching a maximum positive peak and a minimum negative peak during each cycle of the AC signal. The peak-to-peak voltage may be calculated by taking the difference between these two extreme voltage levels. Pre-startup voltage may refer to a voltage of the machine prior to a startup event. Crank engine speed may refer to a rotational speed of an engine's crankshaft. The crank engine speed may be measured, e.g., in revolutions per minute (RPM), representing the number of complete rotations the crankshaft makes in one minute. Startup duration may refer to the time it takes for a system or machine to go from an off or idle state to a fully operational or active state. Further, the startup duration may refer to the duration of the initial phase during which the system's components, circuits, or processes are being initialized, powered up, and brought to their functional state. The control parameters may be transmitted to the sensor module. Alternatively, the sensors may be communicatively coupled to the sensor module and the sensor module may receive the control parameters directly via the sensors.

Device 104 may also include data acquisition unit 110 communicatively coupled to the sensor module 105. Data acquisition unit 110 may be configured to receive control parameters 102 from sensor module 105. Data acquisition unit 110 may also be configured to store and transmit control parameters 102 to at least one processor. Data acquisition unit 110 may further be configured to receive and store machine-related data 122 (e.g., via user input or another data input method). Machine-related data 122 may refer to data provided in specifications, maintenance logs, service logs, or other historical data and/or descriptions associated with the monitored machine itself or components thereof (e.g., battery, starter, alternator, cabling, or another component). Data acquisition unit 110 may comprise hardware, software, a combination of hardware and software, or special purpose hardware. Data acquisition unit 110 may be used to collect, measure, and record data from various sensors (e.g., via the sensor module) or other sources in real-time. Data acquisition unit 110 may interface with sensors or sensor module 105, or data acquisition unit 110 may receive input signals, convert analog signals into digital data, and store or transmit the acquired data for further analysis or processing (e.g., to at least one processor).

Device 104 may further include at least one processor (e.g., processor(s) 118) communicatively coupled to the data acquisition unit. The at least one processor may pull data (e.g., control parameters) from the data acquisition unit 110. Alternatively, data acquisition unit 110 may transmit data to the at least one processor. A system of one or more computers may be configured to perform particular operations or actions by virtue of having software, firmware, hardware, or a combination thereof installed on the system that, in operation, causes or causes the system to perform the actions. One or more computer programs may be configured to perform particular operations or actions by virtue of including instructions that, when executed by at least one processor, cause the at least one processor to perform the actions.

The at least one processor may be configured to determine a performance standard for the machine using a physics-based model 124 and historical data associated with the particular machine or the machine type (e.g., machine-related data 122, which may include maintenance or service data of the machine or machine type, previously received control parameters of the machine or machine type, or other previously received or recorded test data associated with the machine or machine type). A physics-based model may refer to a mathematical and/or graphical representation that relies on the fundamental principles and laws of physics to describe and predict the behavior of a given machine (e.g., an engine or generator). A physics-based model may involve equations and relationships derived from, e.g., electromagnetic theory, circuit theory, thermodynamics, fluid mechanics, or combustion theory. A physics-based model may incorporate or consider variables, parameters, and initial conditions that describe the electrical, mechanical, thermodynamic, or fluid properties associated with a given machine. A physics-based model may also take into account the principles of electromagnetism, such as Faraday's law of electromagnetic induction, which explains how a changing magnetic field induces an electromotive force (EMF) in a conductor, or the principles of thermodynamics, which govern the conversion of heat energy into mechanical work. A physics-based model may also consider one or more mechanical aspects of the machine, including the rotational motion and the conversion of mechanical energy into electrical energy. A physics-based model may range from simple analytical models, such as the idealized behavior of an ideal machine, to more complex computational models that account for factors like magnetic saturation, losses, heat transfer, turbulence, chemical kinetics, and non-linearities in the system.

For example, the performance standard may be generated by utilizing control parameters including voltage data collected from an existing machine. During every startup event for a machine, control parameters such as system voltage, engine crank speed, coolant temperature, ambient temperature, and other high frequency data may be automatically recorded. Further, a health of the battery may be monitored using one or more indicators from a machine or system based on a comparison with a performance standard. These indicators may include one or more of minimum voltage during a startup event, step voltage after recovering from a minimum voltage, or a peak-to-peak value of voltage (e.g., peak-to-peak voltage) during startup. Additionally, a crank engine speed and startup duration may be collected. Startup monitoring may thus include detecting a failure of the alternator and/or an abnormality in engine crank speed by comparing control parameters with the performance standard. The performance standard may be provided as a reference of a healthy startup event based on previously received parameters, information from the physics-based model, which may be running in real time, and maintenance log data from when a battery of the machine is replaced. A history trend of relevant voltage parameters (e.g., minimum voltage, maximum voltage, peak-to-peak voltage, step voltage) may also be used to determine a performance standard associated with a healthy battery.

A performance standard may refer to predefined criteria or specifications that define the expected performance characteristics and/or capabilities of a machine. A performance standard may serve as a benchmark or guideline against which the performance of the machine may be evaluated and compared. A performance standard may typically be established based on a combination of engineering considerations, industry standards, regulatory requirements, and specific application needs. A performance standard may include parameters such as power output or power rating, efficiency, voltage and frequency stability, emissions, durability, reliability, or noise or vibration levels. A physics-based model may be used to determine a performance standard by providing a quantitative understanding of a given machine's behavior and characteristics based on, e.g., previously received parameters and maintenance log data from when a battery of the machine is replaced. By simulating or solving the mathematical equations that describe the machine's operation, as indicated by, e.g., previously received parameters or maintenance log data from when a battery of the machine is replaced, the model may generate predictions and insights into the machine's performance metrics.

The at least one processor may also utilize historical data to determine the performance standard. Historical data may refer to past performance data of the actual machine or of the machine type. Past performance data may include parameters such as power output at various stages, efficiency, emissions, durability, and other performance metrics of the machine or machine type. In some embodiments, the historical data may include information recorded during a battery replacement event associated with the machine. Such information may include the date and time when the battery replacement event took place, battery parameters (e.g., capacity, voltage rating, chemistry, type, or another battery property), the location where the battery replacement event occurred, condition assessment data of the prior battery (e.g., remaining capacity, voltage readings, internal resistance, battery health, voltage drop test data, load testing data, or other diagnostic data), post-replacement data (e.g., initial voltage readings, capacity measurements, or another performance metric of the replacement battery), and maintenance and service notes (e.g., observations or comments related to the battery replacement event or maintenance procedures performed or recommended). Utilizing historical data to determine the performance standard may involve analyzing past performance data to establish benchmarks and criteria for future performance. For example, the collected historical data may be analyzed to identify trends, patterns, and/or performance characteristics. Statistical techniques may also be utilized to derive insights and quantify the performance metrics. Based on the analysis and/or statistical techniques, standard performance levels exhibited by the machine or machine type may be identified. Such standard performance levels may represent the typical or average performance observed in the historical data set and may serve as a reference point for establishing the performance standard. The specific performance metrics (e.g., power output, efficiency, emission levels, durability indicators, or another relevant parameter) used to establish the performance standard may be determined. Additionally or alternatively, acceptable thresholds or requirements for each performance metric may be defined. Such thresholds may be based on industry standards, regulatory requirements, best practices, or specific application needs. Further, inherent variations and uncertainties in data (e.g., measurement errors, variations in operating conditions, variations in equipment or operational methodologies) may be taken into account, and suitable margins or allowances may be incorporated to accommodate such variations.

In some embodiments, a machine learning model 120 (e.g., machine learning algorithm) and calibration window may be developed to adapt the performance standard to different applications, different temperatures, and/or different locations. As such, the at least one processor may further be configured to adjust the determined performance standard using the machine learning model 120 to account for at least one variation (e.g., a systemic, equipment-related, component-related, environmental, or geographic variation) associated with the machine. For example, one or more machine learning models or algorithms may be employed to recognize and/or understand trends or patterns within the performance standard data generated using the physics-based model and/or historical data. As another example, one or more machine learning models or algorithms may be employed to understand anomalies in detected control parameters based on additional historical data such as location data, environmental condition data, equipment-specific data, component-specific data, or other variational data and an effect of that data on measured control parameters. Some non-limiting examples of machine learning algorithms that may be used include classification algorithms, data regressions algorithms, mathematical embedding algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning algorithm may include an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes, and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have one or more parameters and/or hyper parameters, where the hyper parameters may be set manually by a person or automatically by a process external to the machine learning algorithm (such as a hyper parameter search algorithm), and the parameters of the machine learning algorithm may be set by the machine learning algorithm according to the training examples. In some implementations, the hyper-parameters are set according to the training examples and the validation examples, and the parameters are set according to the training examples and the selected hyper-parameters. The parameters and/or hyperparameters may further be adjusted such that the output of the machine learning algorithm matches the training examples and the validation examples.

In some embodiments, adjusting the performance standard may involve a trained machine learning algorithm that is used as an inference model that when provided with an input generates an inferred output. For example, a trained machine learning algorithm may include a regression model, the input may include a sample variation, and the inferred output may include an inferred adjustment value for the sample variation. In another example, a trained machine learning algorithm may include a clustering model, the input may include a sample variation, and the inferred output may include an assignment of the sample variation to at least one cluster. In some examples, the trained machine learning algorithm may include one or more formulas and/or one or more functions and/or one or more rules and/or one or more procedures, the input may be used as input to the formulas and/or functions and/or rules and/or procedures, and the inferred output may be based on the outputs of the formulas and/or functions and/or rules and/or procedures (for example, selecting one of the outputs of the formulas and/or functions and/or rules and/or procedures, using a statistical measure of the outputs of the formulas and/or functions and/or rules and/or procedures, and so forth).

The embodiments discussed herein involve or relate to artificial intelligence (AI). AI may involve perceiving, synthesizing, inferring, predicting and/or generating information using computerized tools and techniques (e.g., machine learning). For example, AI systems may use a combination of hardware and software as a foundation for rapidly performing complex operation to perceive, synthesize, infer, predict, and/or generate information. AI systems may use one or more models (e.g., machine learning models), which may have a particular configuration (e.g., model parameters and relationships between those parameters, as discussed below). While a model may have an initial configuration, this configuration may change over time as the model learns from input data (e.g., training input data), which may allow the model to improve its abilities. For example, a dataset may be input to a model, which may produce an output based on the dataset and the configuration of the model itself. Then, based on additional information (e.g., an additional input dataset, validation data, reference data, feedback data), the model may deduce and automatically electronically implement a change to its configuration that may lead to an improved output.

Powerful combinations of model parameters and sufficiently large datasets, together with high-processing-capability hardware, can produce sophisticated models. These models enable AI systems to interpret incredible amounts of information according to the model being used, which would otherwise be impractical, if not impossible, for the human mind to accomplish. The results, including the results of the embodiments discussed herein, are astounding across a variety of applications. For example, an AI system can be configured to autonomously navigate vehicles, automatically recognize objects, instantly generate natural language, understand human speech, and generate artistic images.

In some embodiments, artificial neural networks may be configured to analyze inputs and generate corresponding outputs. Some non-limiting examples of such artificial neural networks may include shallow artificial neural networks, deep artificial neural networks, feedback artificial neural networks, feed-forward artificial neural networks, autoencoder artificial neural networks, probabilistic artificial neural networks, time-delay artificial neural networks, convolutional artificial neural networks, recurrent artificial neural networks, long/short term memory artificial neural networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

Machine learning model 120 may also be utilized to extrapolate or extend the performance standard to values which are not encompassed in the control parameters or historical data that are utilized in generating the physics-based model. For example, the machine learning model may extrapolate the slope or trend of a given graphical representation generated by the physics-based model such that the graphical representation extends past the values provided by sensed parameters and/or historical data associated with the machine or machine type. As a result, control parameters which are collected but which fall outside the scope embodied by the physics-model's graphical representation itself may still be useful in generating calculated parameters (and thereby a health value of the machine) based on the control parameters collected.

In some embodiments, adjusting the performance standard using a machine learning model 120 may include modifying the criteria or metrics used by physics-based model 124 to generate the performance standard. Such modification may involve setting one or more thresholds or targets for specific measures such that the performance of the physics-based model 124 and/or the accuracy of the performance standard may be optimized to meet the one or more thresholds or targets. In some embodiments, the physics-based model 124 may be incorporated into the machine learning framework, and adjusting the performance standard may involve finding a balance between the physics-based model's predictions and the machine learning model's predictions. In some embodiments, adjusting the performance standard may involve using machine learning model 120 in conjunction with physics-based model 124 to enhance the effectiveness of physics-based model 124. For example, physics-based models may rely on simplified assumptions and idealized parameters, which may not fully capture the complexity of combinations of control parameters collected. Machine learning may be used to calibrate the parameters used by physics-based model 124. By training machine learning model 120 to learn the mapping between inputs and outputs of the physics-based model, machine learning model 120 may help refine the physics-based model's parameters to align better with observed data. Machine learning model 120 may also learn to correct or refine the outputs of physics-based model 124 by considering additional data sources or real-world observations (e.g., variations). Machine learning model 120 may be trained to capture the discrepancies or errors between the physics-based model's predictions and actual observations. Machine learning model 120 may then provide corrected or refined predictions to improve the accuracy of physics-based model 124. Physics-based models may also struggle with modeling complex or uncertain components of a system or machine. Machine learning may therefore also be employed to model such components using data-driven approaches. By training the machine learning model on relevant data, the machine learning model may capture intricate relationships and patterns that physics-based model 124 may not represent accurately. Machine learning model 120 may then supplement or replace these components in the overall modeling process. In some embodiments, rather than replacing physics-based model 124 entirely, machine learning model 120 may be used in combination with physics-based model 124 to combine the strengths of both approaches. Physics-based model 124 may provide a solid foundation based on fundamental principles, while machine learning model 120 may capture additional nuances and complexities from the data. By combining the predictions of both models, one may leverage the interpretability and generalizability of physics-based model 124 with the data-driven flexibility of machine learning model 120. Furthermore, because physics-based models often struggle to quantify uncertainties accurately, machine learning models, particularly probabilistic models, may be used to estimate uncertainty in predictions by modeling the inherent uncertainty present in the data. These uncertainty estimates may help provide more reliable and robust predictions from physics-based model 124, especially in situations where the underlying physics may not fully capture all the variations and uncertainties in the system.

In some embodiments, the at least one processor may be configured to analyze the received control parameters 102 to generate an output 112 (e.g., at least one calculated parameter of the machine based on the adjusted performance standard). A calculated parameter may refer to a performance metric associated with the machine or system being monitored which is not directly indicated by a control parameter 102 or machine-related data 122 (e.g., a calculated parameter may include a parameter that requires some inference or calculation to be performed based on the performance standard or using a function of at least one of the physics-based model 124 or the machine learning model 120). Calculated parameters may include, e.g., a state of health (SOH) of a battery, SOH of an alternator, SOH of a starter, remaining useful life (RUL) of a battery, RUL of an alternator, RUL of a starter, and/or a state of charge (SOC) of a battery. Calculated parameters may also include varying levels of SOH, RUL, and/or SOC of one or more components of the monitored machine or system. For example, a SOH of a battery, alternator, or starter may include three levels of indicators (e.g., green, yellow, and red; good, fair, and low; etc.). A green/good level may indicate a healthy component, a yellow/fair level may indicate an aging component, and a red/low level may indicate a failing component that may require replacement. As an example, if a system voltage is indicated as normal, based on the adjusted performance standard, after a last startup event and also just before a current startup event, a calculated parameter may include a good SOH of the battery which may indicate a new and healthy battery. As another example, during the charging of the alternator of a machine, a monitored system voltage that is not maintained at a normal voltage level (based on the adjusted performance standard) may lead to an indication of a failing alternator because the alternator cannot maintain the system voltage at a normal level (based on the adjusted performance standard). As a result, such control parameters may lead the at least one processor to indicate a low SOH of the alternator. As an additional example, if a monitored system voltage during startup is at a normal level (based on the adjusted performance standard) but a monitored crank engine speed is abnormally low, the at least one processor may indicate a low SOH of the starter (and/or a low SOH of the cabling connection) because a component connecting the seemingly healthy battery with the engine may be failing.

The at least one processor may also be configured to display, via a user interface 108, a startup health indicating at least one startup condition of the machine based on the determined at least one calculated parameter. The startup health of the machine may include an overall health of the machine (e.g., incorporating any combination of determined calculated parameters to determine the total health of the machine). For example, if the SOH of a battery is good but the SOH of an alternator is low, the startup health of the machine may be determined based on the component having the lower SOH and thus be displayed as low, such that an operator or user may be informed of the need to address the alternator. As another example, if the SOH of the battery, alternator, and starter are all good, the startup health of the machine may be determined and displayed as good.

In some embodiments, the at least one processor may further be configured to generate output 112 including an alert signal when the at least one calculated parameter indicates a failure. A failure may be indicated, e.g., when the at least one calculated parameter is below a predetermined threshold. For example, if a calculated parameter is determined to be at a low (or red) level, as compared with a predetermined threshold, the at least one processor may generate an alert which may be displayed via the user interface. Alternatively, the alert signal may include a sound or vibration that is emitted to signify a failing component to an operator or user.

In some embodiments, at least one sensor or the sensor module 105 may be configured to detect the at least one control parameter 102 at a position located before a low pass filter of the machine. A low pass filter may refer to an electronic filter or signal processing circuit used to attenuate or block higher-frequency components of the electrical output produced by the machine, allowing only low-frequency components to pass through relatively unaffected. A low pass filter may typically be employed to remove high-frequency noise, harmonics, or disturbances from the machine's output. By detecting the at least one control parameter 102 at a position before the low pass filter, the sensor module 105 may receive a signal indicating the at least one control parameter 102 measured at a point where both high and low frequencies may be detected and thus where the signal is most accurate (e.g., prior to being filtered by a low pass filter, which may remove frequencies above a certain threshold level, thereby potentially making the measurement of a control parameter less accurate). It will also be understood that detecting the at least one control parameter 102 at such a position may help collect additional high frequency components or signals which may allow for additional data to be recorded and included as input into the physics-based model. As a result of the additional input data, the generation of the performance standard by the physics-based model 124, and/or the adjustment of the performance standard by the machine learning model 120, may be improved. For example, in capturing data during a startup event, high frequency voltage may be measured or calculated (e.g., the captured frequency may oscillate between 60 Hz to 1000 Hz, thereby indicating both high frequencies and low frequencies), and such high frequency voltage may be captured before a low pass filter (e.g., measuring or calculating voltage before a 1 Hz low pass filter) in order to capture the most accurate relevant data which includes both the high and low frequencies detected. However, it will be further understood that a filtered signal may instead be utilized, wherein captured voltage values (e.g., minimum voltage) may be adjusted by the machine learning model 120, e.g., based, e.g., on a sampling rate.

In some embodiments, the at least one calculated parameter may include at least one of a condition of a battery, a condition of an alternator, a condition of a generator, a condition of a starter, a condition of a cabling connection, or a condition of a crank engine. A condition may refer to, e.g., a health, state of health, state of charge, or remaining useful life of a given component of the machine or system being monitored.

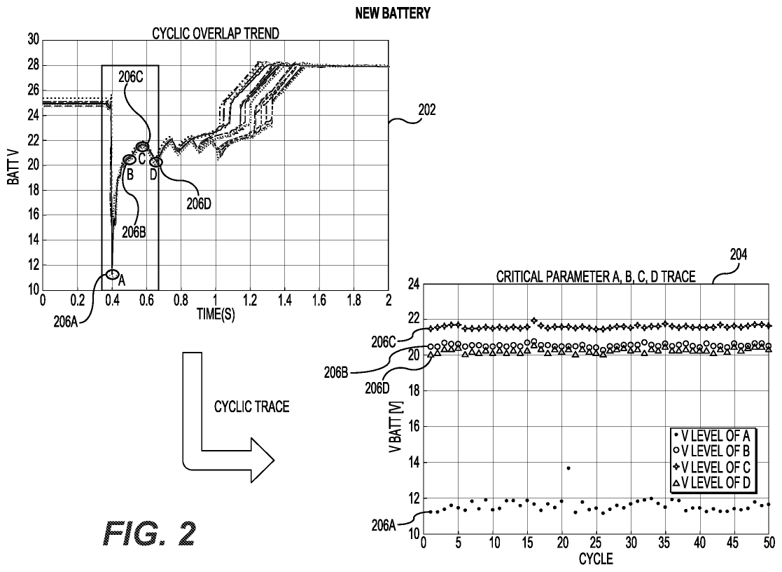

FIG. 2 illustrates an exemplary process of generating a performance standard of a given machine based on control parameters and/or historical data. FIG. 2 shows two graphical illustrations depicting a cyclic overlap 202 and a cyclic trace 204 of a new or healthy battery showing a detected control parameter (battery voltage) as a function of time (seconds) or as a function of startup event cycles. A cyclic overlap may refer to a graphical representation of one or more control parameters received over a plurality of startup events. As shown in cyclic overlap 202, the battery voltage control parameter values over a plurality of cycles (e.g., startup events) remain nearly constant, as indicated by the overlapping of the various solid and dotted lines over at least a similar portion of the plurality of startup events (e.g., between 0.4 and 0.8 seconds in cyclic overlap 202), each of which represents a different startup event. As shown in the example of FIG. 2, the solid line represents a first startup event cycle and the various dotted lines represent subsequent startup event cycles. The instantaneous voltage (y-axis) as a function of time (x-axis), as well as relevant control parameter values A, B, C, and D 206A-206D, are shown for a plurality of startup cycles of the given machine. Such overlapping may indicate a lack of fluctuations or other changes in the data. The same lack of fluctuations or other changes in the data may be represented by cyclic trace 204, which illustrates the same relevant control parameter values (y-axis) as a function of consecutive startup event cycles (x-axis). By tracing the relevant parameter values, A, B, C, and D 206A-206D, over a plurality of cycles, the detected relevant parameter values from graphical representation 202 may be utilized to illustrate a trend over consecutive startup cycles (e.g., cyclic trace 204). Based on either one or both of cyclic overlap 202 and cyclic trace 204, a performance standard associated with a machine with a new or healthy battery may be generated, wherein the relevant control parameter values A, B, C, and D 206A-206D, and thereby the performance standard, are shown to have a zero or near-zero slope (e.g., the relevant control parameter values are generally consistent over the plurality of startup event cycles).

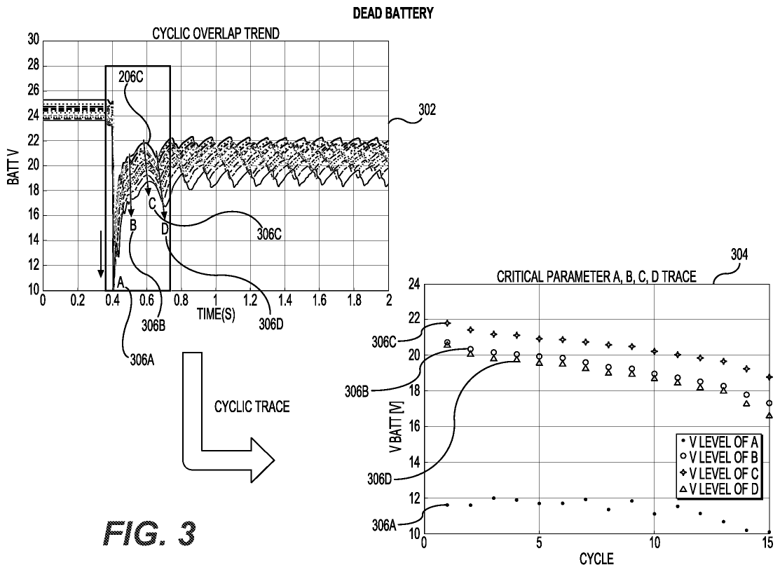

FIG. 3 illustrates another exemplary process of generating a performance standard of a given machine based on historical data. FIG. 3 shows two graphical illustrations depicting a cyclic overlap 302 and a cyclic trace 304 of a dead or dying battery showing relevant control parameter values (battery voltages) as a function of time (seconds) or as a function of consecutive startup event cycles. As shown in cyclic overlap 302, the battery voltage control parameter values over a plurality of cycles (e.g., startup events) continuously drop, as indicated by the non-overlapping of the various solid and dotted lines, each of which represents a different startup event. As shown in the example of FIG. 3, the solid line represents a first startup event cycle and the various dotted lines represent subsequent startup event cycles. The instantaneous voltage (y-axis) as a function of time (x-axis), as well as relevant control parameter values, A, B, C, and D 306A-306D, are shown for a plurality of startup cycles of the given machine, and a lowering trend is shown based on the non-overlapping control parameter values. Such non-overlapping may indicate fluctuations or other changes in the control parameter data. The same fluctuations or other changes in the data may be represented by cyclic trace 304, which illustrates the same relevant control parameter values (y-axis) as a function of consecutive startup event cycles (x-axis). By tracing the relevant parameter values, A, B, C, and D 306A-306D, over a plurality of cycles, the detected relevant parameter values from cyclic overlap 302 may be utilized to illustrate a trend over consecutive startup cycles (e.g., cyclic trace 304). Based on either one or both of cyclic overlap 302 and cyclic trace 304, a performance standard associated with a machine with a aged or dying battery may be generated, wherein the relevant control parameter values A, B, C, and D 306A-306D, and thereby the performance standard, are shown to have a less than zero slope because the relevant control parameter values, A, B, C, and D 306A-306D, are consistently dropping over the plurality of startup cycles.

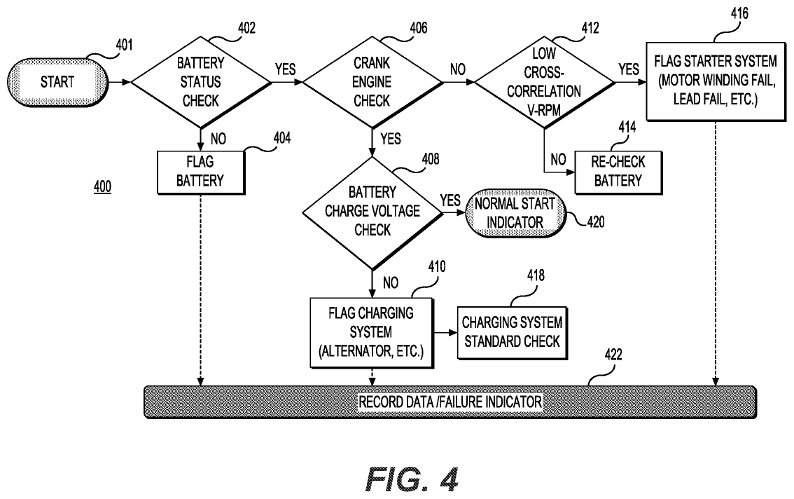

FIG. 4 illustrates a decision tree flow chart illustrating an exemplary process 400 for generating calculated parameters based on collected control parameters of a monitored machine. Collected control parameters may be deemed normal or not normal as compared to a determined performance standard (e.g., based on the performance standard exemplified in FIG. 2). In some embodiments, the performance standard may be adjusted using a machine learning model prior to a determination of whether a control parameter is normal or not normal. As shown in FIG. 4, upon a given startup event 401 of a machine, a battery status check 402 may be implemented. A battery status check 402 may involve, e.g., determining whether a system voltage is normal (based on a determined and/or adjusted performance standard associated with the battery). If the battery status check indicates an abnormal value of a collected control parameter (e.g., no), a failing battery status may be indicated 404 and/or the abnormality may be recorded or displayed 422. If the battery status check indicates a normal value of a collected control parameter (e.g., yes), a crank engine check 406 may be implemented. A crank engine check 406 may involve, e.g., determining whether a crank engine speed is normal (based on a determined and/or adjusted performance standard associated with the crank engine). If the crank engine check 406 indicates a normal value of collected control parameters (e.g., yes), a battery charge voltage check 408 may be implemented via an alternator status check. A battery charge voltage check 408 may involve, e.g., determining whether the system voltage is maintained at a normal voltage level during charging of the battery via the alternator (based on a determined and/or adjusted performance standard associated with the system voltage, battery, and or alternator). If the battery charge voltage check indicates a normal battery charge (e.g., yes), an indicator of a normal startup health 420 of the machine may be displayed, e.g., via the user interface. If, however, any one of the battery status check, the crank status check, or the battery charge voltage/alternator status is not normal, a failure of that component may be detected and/or recorded and an alert signal (e.g., failure indicator) may be output 422. For example, if the battery status is not normal (e.g., no), the battery may be flagged to indicate a failure associated with the battery. If the crank status check indicates an abnormal crank status (e.g., no), the process 400 may further include performing a cross correlation check 412. For example, the cross correlation check 412 may determine whether there is a low cross-correlation between voltage and engine crank speed (V-RPM). If low cross-correlation between V-RPM is determined, a failure associated with the starter system of the machine (e.g., motor winding failure, lead failure, cross cabling connection, etc.) may be indicated 416. Further, the failure data may be recorded and/or indicated 422 via, e.g., a user interface. If a low cross-correlation between V-RPM does not exist but the crank status is determined to be abnormal, the process 400 may include re-checking the battery status. If the additional battery status check 414 once again indicates a normal battery, this may indicate and confirm that the source of the abnormality lies in the crank engine rather than the battery. If the additional battery status check 414 instead indicates an abnormal battery, this may likely indicate that the source of the abnormality includes the battery (and perhaps also the crank engine). If the battery charge voltage check 408 indicates an abnormal charge voltage (e.g., no), but the battery status check 402 and the crank engine status check 406 indicate normal statuses, the charging system (e.g., alternator) of the machine may be flagged 410 to indicate a failure associated with the charging system, and the failure data may be recorded and/or indicated 422 via e.g., a user interface. Further, a charging system standard check 418 may be implemented based on the flagged charging system. Any indicated failure of any component of the system may further be indicated 422 via an alert signal transmitted to an operator or user via, e.g., the user interface. It will be understood that FIG. 4 is an exemplary flow chart and may be altered to rearrange steps, or include additional steps, or delete some steps. Further, the flow chart of FIG. 4 may be modified to include fewer and/or additional checks relative to what is illustrated in the figure.

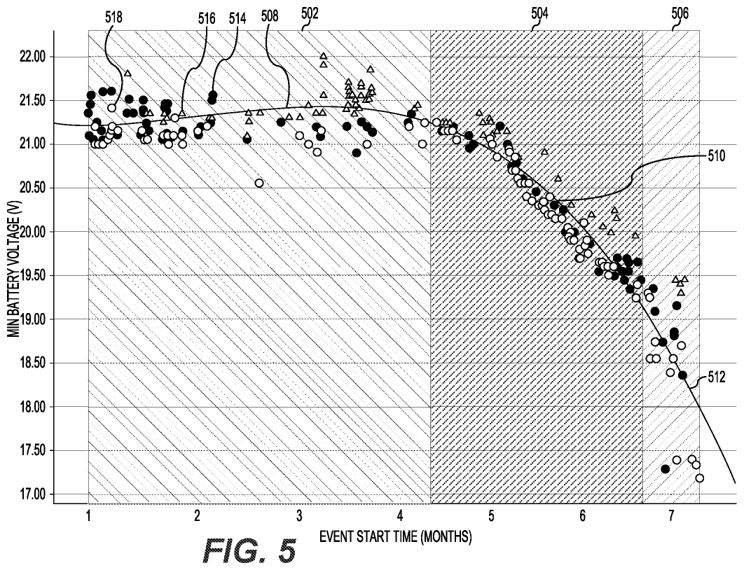

FIG. 5 illustrates an exemplary graphical representation of a minimum battery voltage parameter of a monitored machine during consecutive startup events (e.g., minimum battery voltage trend chart). Solid line 508 in the exemplary graphical representation may function as a performance standard for a given battery of a machine, wherein the performance standard is estimated based on various data points 514, 516, 518 which represent actual historical, test, and/or validation data. The minimum voltage data may be captured directly from a machine (e.g., customer site). The voltage data may further be separated into three zones 502, 504, 506 within the graphical representation, each zone having a distinct profile of data points 514, 516, 518 and slope of data points 514, 516, 518. The first zone 502 may be associated with a good battery health value and a generally linear slope 508. The second zone 504 may be associated with a fair battery health value and a negative slope 510. The third zone 506 may be associated with a low battery health value and a severely negative slope 512 (e.g., resembling a quick drop in voltage over a short period of time near the end of the RUL of the battery). For example, a minimum battery voltage detected by a sensor upon startup of a machine may be compared to solid line 508 as a performance standard. Based on the comparison between the detected value and solid line 508, a condition of the battery (e.g., calculated parameter) may be determined (e.g., good, fair, low, or a percentage of remaining battery life may be determined, such as any value between 100% and 0%).

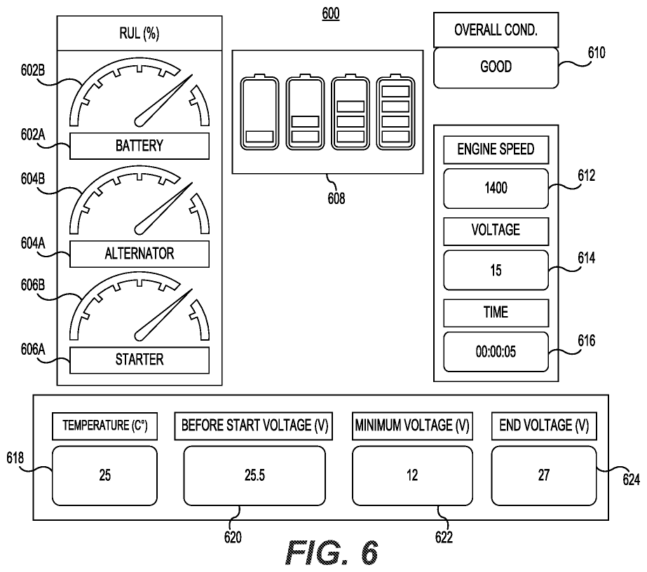

FIG. 6 illustrates exemplary user interface 600 displaying various control parameters, calculated parameters (e.g., startup conditions), and an overall startup health of a machine. As shown in FIG. 6, exemplary user interface 600 may display control parameters such as temperature 618, pre- startup voltage 620, minimum voltage during startup 622, end voltage 624, engine speed 612, machine voltage 614, and startup duration 616 (e.g., in seconds) as detected by a sensor module. As further shown in FIG. 6, exemplary user interface 600 may display calculated parameters such as remaining useful life (RUL) of each one of the battery 602A and 602B, the alternator 604A and 604B, and the starter 606A and 606B of the monitored machine, the calculated parameters being determined based on the collected control parameters and machine-related data, as well as the performance standard. While FIG. 6 shows an example of visualizations including gauges 602B, 604B, 606B and labels 602A, 604A, 606A representing each RUL and respective component, it will be understood that various visualizations may be presented for the RUL values and components, such as digital alphanumeric visualizations and other graphics not limited to gauges or labels (e.g., percentage bars, estimated time remaining, level indicators, color-coded displays, graphs, notifications, etc.). Further, as shown in FIG. 6, exemplary user interface 600 may indicate one of four battery icons 608 (e.g., a battery icon with one bar, a battery icon with two bars, a battery icon with three bars, or a battery icon with 4 bars) which represent, e.g., a RUL of the battery. Alternatively, battery icon 608 may represent a RUL of the alternator, starter, or machine. In addition, as shown in FIG. 6, exemplary user interface 600 may display a startup health of the machine 610 (e.g., overall condition, which may be indicated as, e.g., good, fair, low, or failing), wherein the startup health of the machine is based on a combination of calculated parameters.

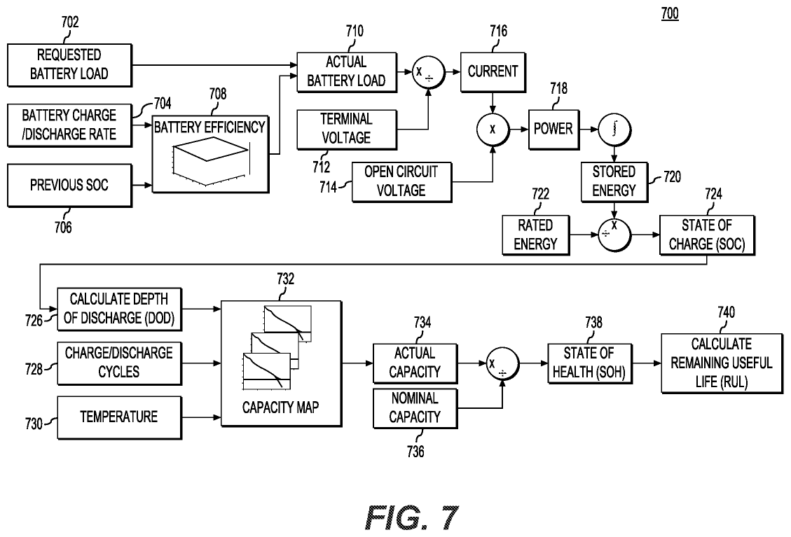

FIG. 7 illustrates a flowchart showing an exemplary process 700 (e.g., a process used by a high fidelity model) for determining calculated parameters (e.g., a state of charge (SOC), state of health (SOH), and RUL of a battery), which may be implemented by the at least one processor, the machine learning model, or another component. A high fidelity model may refer to a model that accurately represents or simulates the characteristics or patterns of a real-world system (e.g., a monitored machine or system). The term, fidelity, refers to the degree of faithfulness or accuracy of the model in capturing the underlying reality. The high fidelity model may be designed to closely mimic the real-world system as accurately as possible. The high fidelity model may incorporate a wide range of factors, features, or variables that influence the behavior or outcome of the system (e.g., past control parameters, current control parameters, historical data, machine specifications, component specifications, etc.).

As shown in FIG. 7, an exemplary process 700 performed by a high fidelity model for calculating a remaining useful life of a battery of a machine may include a step 702 of determining a requested battery load (e.g., a requested ability of the battery to deliver starting current and maintain sufficient voltage to operate the machine), a step 704 of determining a battery charge/discharge rate (e.g., a measurement indicating a length of time during which the battery should be able to provide power), and a step 706 of determining a previous state of charge (SOC) (e.g., a level of charge of the battery relative to its capacity) of the battery. Process 700 may further include a step 708 of determining battery efficiency (e.g., a measurement of the amount of energy output by the battery relative to the amount of energy input into the battery) based on the determined charge/discharge rate and previous SOC. Process 700 may further include a step 710 of determining an actual battery load (e.g., actual current drawn from the battery) based on the determined battery efficiency and the requested battery load. Process 700 may further include a step 712 of determining a terminal voltage (e.g., a voltage difference between the terminals) of the battery. Process 700 may further include a step 716 of determining a current associated with the battery based on the determined actual battery load and the terminal voltage. Process 700 may further include a step 714 of determining an open circuit voltage (e.g., a voltage difference between terminals of the machine). Process 700 may further include a step 718 of determining a power value (e.g., power value=current*voltage) based on the determined open circuit voltage and the determined current. Process 700 may further include a step 720 of determining a stored energy value (e.g., a value indicating an amount of stored energy within the machine) based on the determined power value. Process 700 may further include a step 722 of determining a rated energy value (e.g., a power rating of the machine, such as maximum power output). Process 700 may further include a step 724 of determining a state of charge (SOC) based on the rated energy value and the stored energy value. Process 700 may further include a step 726 of calculating a depth of discharge (DOD) (e.g., the percentage of the battery that has been discharged relative to the overall capacity of the battery). Process 700 may further include a step 728 of determining an amount of charge/discharge cycles (e.g., the number of startup events since the battery was installed). Process 700 may further include a step 730 of determining a temperature (e.g., an ambient temperature or a temperature of the battery). Process 700 may further include a step 732 of generating a capacity map (e.g., a graphical representation of the total amount of electricity generated by the battery as a function of total discharge current) based on the calculated DOD, the determined number of charge/discharge cycles, and the determined temperature. Process 700 may further include a step 734 of determining an actual capacity (e.g., the actual amount of electricity generated by the battery as a function of total discharge current) of the battery based on the generated capacity map. Process 700 may further include a step 736 of determining a nominal capacity of the battery (e.g., the amount of charge delivered by a fully charged battery under particular conditions of temperature and load). Process 700 may further include a step 738 of determining a state of health (SOH) of the battery (e.g., the level of degradation of the battery and/or the remaining electricity available in the battery) based on the determined actual capacity and nominal capacity. Process 700 may further include a step 740 of calculating a remaining useful life (RUL) (e.g., a value indicating how many startup cycles remain before the battery capacity will reach failure, or a failure threshold value) based on the determined SOH (e.g., by determining a point in time when the determined SOH would be zero).

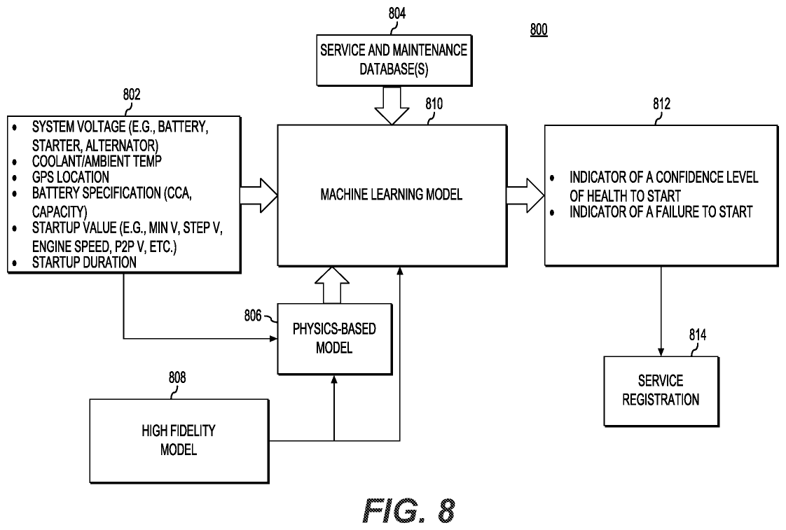

FIG. 8 illustrates a block diagram showing an exemplary operating environment 800 for an exemplary machine learning model 810, wherein the machine learning model 810 receives inputs and provides outputs. As shown in FIG. 8, a health of a machine or system (e.g., battery, motor, alternator, starter) may be determined as a function of input data provided to machine learning model 810. The input data may include service and maintenance data (e.g., data from a dealer database or an integrated vehicle health management system (IVHM)) 804, control parameters collected by various sensors located within the machine or system (e.g., recorded data such as system voltage (e.g., battery voltage, starter voltage, alternator voltage), battery capacity and/or cold cranking amps (CCA) rating, engine crank speed, coolant temperature, ambient temperature, or other high frequency data collected during a startup of the machine) 802, data received from a high fidelity model 808, and data received from a physics-based model 806. The data from the physics-based model 806 may comprise, e.g., a performance standard, and the performance standard may be determined by the physics-based model 806 based on the control parameters 802 and/or data from the high fidelity model 808. Alternatively or additionally, the performance standard may be determined by the physics-based model 806 based on data received from service and maintenance databases 804 (not shown in FIG. 8). The input to the machine learning model 810 may further include control parameters related to a monitored machine or system (e.g., minimum voltage during startup event (MIN V), step voltage after recovering from a dip (STEP V), peak-to-peak value of voltage during startup (P2P V), ambient temperature, coolant temperature, crank engine speed, and/or startup duration) 802. The machine learning model 810 may adjust the performance standard determined by the physics-based model 806 after taking into account variations in the form of, e.g., additional control parameters detected, received, and associated with the machine (e.g., environmental temperature, geographical location, other environmental factors, etc.), from control parameters 802. Variations may include, e.g., systemic variations, component-based variations, equipment-based variations, environmental variations, geographic variations, or other variations which would require further calibration of a performance standard). Based on the adjusted performance standard and a comparison of one or more control parameters to the adjusted performance standard, the machine learning model may determine one or more calculated parameters (e.g., state of charge of a battery, state of health of a machine component, remaining useful life of a machine component, etc.). Based on the one or more calculated parameters, the machine learning model may determine an output signal associated with an indicator 812 to be transmitted to a user or operator. The output signal may include information regarding an overall health of the machine (e.g., startup health of the machine), a confidence level of the determined information in the output signal and/or indicator, a health of the machine for a future startup event, and/or an abnormality or failure to start associated with one or more components of the machine (e.g., battery, starter, alternator, cabling connection, etc.). The determined calculated parameters and the overall health of the machine may be displayed via a user interface. Based on the output of the machine learning model, service registration data 814 for the monitored machine may also be recorded. Service registration data may refer to information related to the machine's specifications and maintenance (e.g., power rating, voltage, frequency, or other calculated parameters) in order to keep track of the machine's usage (e.g., for compliance or reporting purposes).

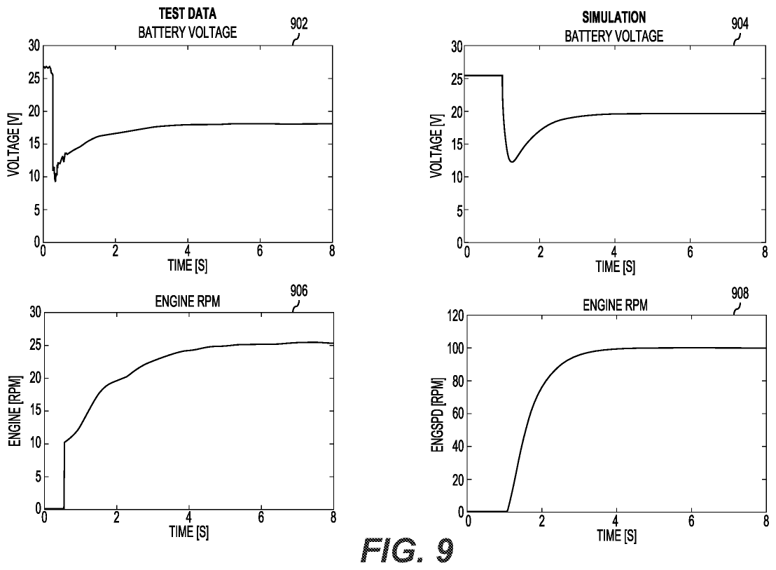

FIG. 9 illustrates a graphical representation of an exemplary simulation of battery voltage 904 based on actual battery voltage test data 902, as well as a graphical representation of an exemplary simulation of engine revolutions per minute (RPM) 908 based on actual engine RPM test data 906. An exemplary physics-based model may generate simulated graphical representations 904, 908 by averaging and/or estimating control parameter values from actual test data 902, 906 to determine a performance standard for a given machine (e.g., averaging or estimating a plurality of past startup events control parameters and/or historical data associated with the machine or machine type, as provided by a data set including test data 902, 906 as well as additional test data for additional startup cycles). Simulated graphical representations 904, 908 may serve as performance standards for the monitored machine or system, and representations 904, 908 may be further adjusted by the machine learning model to account for variations, as described elsewhere herein.

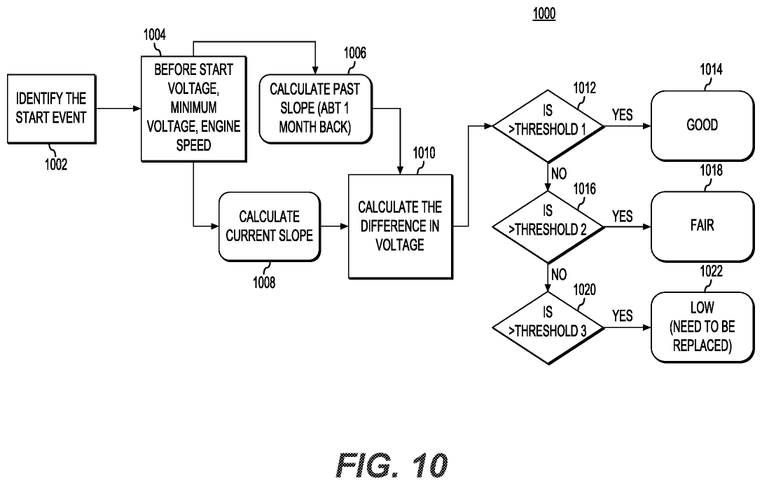

FIG. 10 illustrates a flowchart showing an exemplary process 1000 for generating calculated parameters comprising a health level of a battery. As shown in FIG. 10, a startup event may be identified 1002 (e.g., via user input, a change in one or more detected control parameters, or based on other input data. Based on the identification, one or more pre-startup control parameters 1004 may be determined or recorded (e.g., a pre-startup voltage, a pre-startup minimum voltage, a pre-startup engine speed). Relative to the one or more pre-startup control parameters, a past slope 1006 and a current slope 1008 may each be calculated. For example, a slope associated with control parameter values collected from a time in the past (e.g., one month, week, day, or other time period) may indicate past slope 1006, and a slope associated with currently collected control parameters (e.g., upon startup) may indicate current slope 1008. Further, the determined past slope 1006 and current slope 1008 may be compared in order to determine a difference between slope, which would also indicate the voltage difference between the past data and current data. The indicated voltage difference may be compared with a plurality of thresholds, which may be determined based on one or more performance standards (e.g., as depicted in FIG. 5), to determine a calculated parameter associated with a battery component of a monitored machine or system. For example, as shown in FIG. 10, the indicated voltage difference as determined at step 1010 may be compared against a first threshold value 1012, wherein the first threshold value (and any higher values) indicate a good health level of the battery 1014. As further shown in FIG. 10, if the indicated voltage difference is below the first threshold value 1012, the indicated voltage difference may be compared against a second threshold value 1016 which is lower than the first threshold value 1012. If the indicated voltage difference is above the second threshold value 1016, but below the first threshold value 1012, process 1000 may indicate a fair health level of the battery 1018. As also shown in FIG. 10, if the indicated voltage difference is below the second threshold value 1016, the indicated voltage difference may be compared against a third threshold value 1020 which is lower than the second threshold value 1016. If the indicated voltage difference is above the third threshold value 1020, but below the second threshold value 1016, process 1000 may indicate a low health level of the battery 1022. Additionally, the low health level 1022 may further initiate an output signal indicating a failure, need to replace, and/or an alert or alarm signal.

### INDUSTRIAL APPLICABILITY

The disclosed devices, systems, and methods may provide several advantages. For example, the utilization of existing control parameters to generate calculated parameters removes the need for any additional sensors to be installed on a monitored machine or system, thereby saving costs associated with any such additional sensors as well as costs associated with the storage of data which might otherwise be collected by additional sensors. Additionally, the utilization of a physics- based model in generating a performance standard, particularly in conjunction with a machine learning model which adjusts the performance standard, improves the efficiency and accuracy of detecting abnormalities of collected control parameters in view of, e.g., systemic, equipment-related, component-related, environmental, or geographic variations within or associated with a given monitored machine or system. As a result, the disclosed devices, systems, and method may adapt to different applications, temperatures, and locations without requiring additional sensors or further adjustment or calibration.

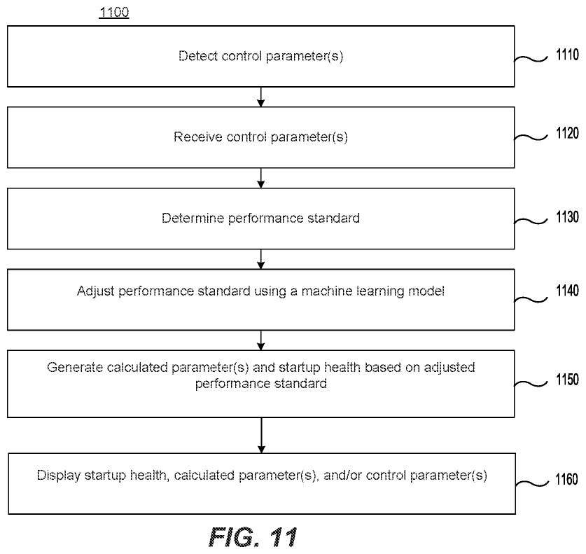

FIG. 11 illustrates a flow chart for an exemplary method 1100 for monitoring a startup condition of a machine, consistent with disclosed embodiments. In one exemplary embodiment, a processor may execute instructions stored in a memory, storage medium, or database to perform method 1100. The order and arrangement of steps in method 1100 is provided for purposes of illustration. As will be appreciated from this disclosure, modifications may be made to method 1100 by, for example, adding, combining, removing, and/or rearranging the steps of method 1100. Method 1100 may be executed by a server and/or a client.

As shown in FIG. 11, method 1100 may include a step 1110 of detecting at least one control parameter 102 of a machine (e.g., via a sensor module 105). The machine may be equipped with sensors which collect control parameters 102 and send the control parameters 102 to at least one processor 118. Control parameters 102 may thus be detected by at least one processor 118. As a result, the at least one processor 118 may detect and measure one or more physical or environmental parameters associated with a machine and convert them into electrical signals for further processing or analysis. Control parameters 102 may refer to one or more performance metrics associated with an operation of the machine, including those which may be typically monitored. Control parameters 102 may be sensed by various sensors located within the machine. These sensors may be provided in the originally manufactured machine rather than being additional sensors installed for operation of the device. Such sensors may collect control parameters 102 including, e.g., machine voltage during or prior to a startup event (e.g., battery voltage, minimum voltage, step voltage, peak-to-peak voltage, pre-startup voltage, or another machine-related voltage), crank engine speed, startup duration of the machine, and machine temperature (e.g., coolant temperature, ambient temperature, or another machine-related temperature).

Method 1100 further may include a step 1120 of receiving the detected control parameters 102 (e.g., via a data acquisition unit 110 communicatively coupled to the at least one processor 118). For example, receiving may include receiving the electrical signals from the at least one processor 118 at a data acquisition unit 110. Receiving may further include storing the received electrical signals, translating the received electrical signals into control parameter data, and transmitting the control parameter data to at least one processor 118.

Further, method 1100 may include a step 1130 of determining a performance standard for the machine (e.g., using a physics-based model 124 and/or service or maintenance logs). The performance standard may serve as a benchmark or guideline against which the performance of the machine may be evaluated and compared. A performance standard may typically be established based on a combination of engineering considerations, industry standards, regulatory requirements, and specific application needs. A performance standard may include parameters such as power output or power rating, efficiency, voltage and frequency stability, emissions, durability, reliability, or noise or vibration levels. A physics-based model 124 may be used to determine a performance standard by providing a quantitative understanding of a given machine's behavior and characteristics based on, e.g., previously received parameters and maintenance log data from when a battery of the machine is replaced. By simulating or solving the mathematical equations that describe the machine's operation, as indicated by, e.g., previously received parameters or maintenance log data from when a battery of the machine is replaced, the model may generate predictions and insights into the machine's performance metrics.

Method 1100 may also include a step 1140 of adjusting the performance standard using a machine learning model (e.g., machine learning algorithm 120) and additional historical data (e.g., to account for at least one of systemic, equipment, environmental, or geographic variations). In some embodiments, adjusting the performance standard using a machine learning algorithm 120 may include modifying the criteria or metrics used by the physics-based model 124 to generate the performance standard. Such modifications may involve setting one or more thresholds or targets for specific measures such that the performance of the physics-based model 124 and/or the accuracy of the performance standard may be optimized to meet the one or more thresholds or targets. In some embodiments, the physics-based model 124 may be incorporated into the machine learning framework, and adjusting the performance standard may involve finding a balance between the physics-based model's predictions and the machine learning model's predictions. In some embodiments, adjusting the performance standard may involve using a machine learning algorithm 120 in conjunction with the physics-based model 124 to enhance the effectiveness of the physics-based model 124. For example, physics-based models may rely on simplified assumptions and idealized parameters, which may not fully capture the complexity of combinations of control parameters collected. Machine learning may be used to calibrate the parameters used by the physics-based model 124. By training the machine learning algorithm 120 to learn the mapping between inputs and outputs of the physics-based model 124, the machine learning algorithm 120 may help refine the physics-based model's parameters to align better with observed data. The machine learning algorithm 120 may also learn to correct or refine the outputs of the physics-based model 124 by considering additional data sources or real-world observations (e.g., variations). The machine learning algorithm 120 may be trained to capture the discrepancies or errors between the physics-based model's predictions and actual observations. The machine learning algorithm 120 may then provide corrected or refined predictions to improve the accuracy of the physics-based model 124. Physics-based models may also struggle with modeling complex or uncertain components of a system or machine. Machine learning may therefore also be employed to model such components using data-driven approaches. By training the machine learning algorithm 120 on relevant data, the machine learning algorithm 120 may capture intricate relationships and patterns that the physics- based model 124 may not represent accurately. The machine learning algorithm 120 may then supplement or replace these components in the overall modeling process. In some embodiments, rather than replacing the physics-based model 124 entirely, a machine learning algorithm 120 may be used in combination with the physics-based model 124 to combine the strengths of both approaches. The physics-based model 124 may provide a solid foundation based on fundamental principles, while the machine learning algorithm 120 may capture additional nuances and complexities from the data. By combining the predictions of both models, one may leverage the interpretability and generalizability of a physics-based model 124 with the data-driven flexibility of a machine learning algorithm 120. Furthermore, because physics-based models often struggle to quantify uncertainties accurately, machine learning models, particularly probabilistic models, may be used to estimate uncertainty in predictions by modeling the inherent uncertainty present in the data. These uncertainty estimates may help provide more reliable and robust predictions from the physics-based model, especially in situations where the underlying physics may not fully capture all the variations and uncertainties in the system.

Method 1100 may further include a step 1150 of generating at least one calculated parameter and a startup health of the machine based on the at least one calculated parameter. A calculated parameter may refer to a performance metric associated with the machine or system being monitored which is not directly indicated by a control parameter or machine-related data (e.g., a calculated parameter may include a parameter that requires some inference or calculation to be performed based on the performance standard or using a function of at least one of the physics-based model 124 or the machine learning algorithm 120). Calculated parameters and/or a startup health may include, e.g., a state of health (SOH) of a battery, SOH of an alternator, SOH of a starter, remaining useful life (RUL) of a battery, RUL of an alternator, RUL of a starter, and/or a state of charge (SOC) of a battery. Calculated parameters may also include varying levels of SOH, RUL, and/or SOC of one or more components of the monitored machine or system. For example, a SOH of a battery, alternator, or starter may include three levels of indicators (e.g., green, yellow, and red; good, fair, and low; etc.). A green/good level may indicate a healthy component, a yellow/fair level may indicate an aging component, and a red/low level may indicate a failing component that may require replacement. As an example, if a system voltage is indicated as normal, based on the adjusted performance standard, after a last startup event and also just before a current startup event, a calculated parameter may include a good SOH of the battery which may indicate a new and healthy battery. As another example, during the charging of the alternator of a machine, a monitored system voltage that is not maintained at a normal voltage level (based on the adjusted performance standard) may lead to an indication of a failing alternator because the alternator cannot maintain the system voltage at a normal level (based on the adjusted performance standard). As a result, such control parameters may lead the at least one processor to indicate a low SOH of the alternator. As an additional example, if a monitored system voltage during startup is at a normal level (based on the adjusted performance standard) but a monitored crank engine speed is abnormally low, the at least one processor may indicate a low SOH of the starter (and/or a low SOH of the cabling connection) because a component connecting the seemingly healthy battery with the engine may be failing.

Further, method 1100 may include a step 1160 of displaying the startup health indicating at least one startup condition of the machine, the at least one calculated parameter, and/or the at least one control parameter (e.g., via a user interface 108). The displayed startup health of the machine may be an overall health of the machine (e.g., incorporating any combination of determined calculated parameters to determine the total health of the machine). For example, if the SOH of a battery is good but the SOH of an alternator is low, the startup health of the machine may be determined and displayed based on the component having the lower SOH and thus be displayed as low, such that an operator or user may be informed of the need to address the alternator. As another example, if the states of health of the battery, alternator, and starter are all good, the startup health of the machine may be determined and displayed as good.

It will be apparent to those skilled in the art that various modifications and variations can be made to the present disclosure. Other embodiments will be apparent to those skilled in the art from consideration of the specification and practice of the disclosed embodiments. It is intended that the specification and examples be considered as exemplary only, with a true scope being indicated by the following claims and their equivalents.

What is claimed is:

1. A startup condition monitoring device, comprising:
a sensor module configured to detect at least one control parameter of a machine; and
a data acquisition unit communicatively coupled to the sensor module, the data acquisition unit being configured to receive the at least one control parameter from the sensor module, store the at least one control parameter, and transmit the at least one control parameter to a processor communicatively coupled to the data acquisition unit;
the processor being configured to:
determine a performance standard for the machine using a physics-based model and historical data;
adjust the determined performance standard using a machine learning model and additional historical data to account for at least one of a systemic, equipment, environmental, or geographic variation;
generate at least one calculated parameter for the machine based on the adjusted performance standard; and
display, via a user interface, a startup health indicating at least one startup condition of the machine based on the determined at least one calculated parameter.

2. The device of claim 1, wherein the machine includes a generator.

3. The device of claim 1, wherein the at least one control parameter comprises at least one of a voltage, a crank engine speed, a startup duration, or a temperature.

4. The device of claim 3, wherein the temperature includes at least one of a coolant temperature or an ambient temperature.

5. The device of claim 3, wherein the voltage includes at least one of a battery voltage, a minimum voltage, a step voltage, or a peak-to-peak voltage.

6. The device of claim 1, wherein the historical data includes service or maintenance information recorded during a battery replacement event.

7. The device of claim 1, wherein the at least one calculated parameter includes at least one of a condition of a battery, a condition of an alternator, a condition of a generator, a condition of a starter, a condition of a cabling connection, or a condition of a crank engine.

8. The device of claim 1, wherein the processor is further configured to generate an alert signal when the at least one calculated parameter is less than a predetermined threshold.

9. The device of claim 1, wherein the performance standard is configured to be adjustable based on one or more of an application of the machine, an environmental temperature around the machine, or a location of operation of the machine.

10. The device of claim 1, wherein the sensor module is configured to detect the at least one control parameter at a position located before a low pass filter of the machine.

11. A system comprising:
a sensor module configured to detect at least one control parameter of a machine;
a data acquisition unit communicatively coupled to the sensor module, the data acquisition unit being configured to receive the at least one control parameter from the sensor module, store the at least one control parameter, and transmit the at least one control parameter to at least one processor; and
at least one memory storing instructions;
the at least one processor being configured to execute the instructions to perform operations comprising:
determining a performance standard for the machine using a physics-based model and historical data;
adjusting the determined performance standard using a machine learning model and additional historical data to account for at least one of systemic, equipment, environmental, or geographic variations;
generating at least one control parameter to determine at least one calculated parameter for the machine based on the adjusted performance standard; and
displaying, via a user interface, a startup health indicating at least one startup condition of the machine based on the determined at least one calculated parameter.

12. The system of claim 11, wherein the at least one control parameter comprises at least one of a voltage, a crank engine speed, a startup duration, or a temperature.

13. The system of claim 12, wherein the temperature includes at least one of a coolant temperature or an ambient temperature.

14. The system of claim 12, wherein the voltage includes at least one of a battery voltage, a minimum voltage, a step voltage, or a peak-to-peak voltage.

15. The system of claim 11, wherein the historical data includes service or maintenance information recorded during a battery replacement event.

16. The system of claim 11, wherein the at least one calculated parameter includes at least one of a condition of a battery, a condition of an alternator, a condition of a generator, a condition of a starter, a condition of a cabling connection, or a condition of a crank engine.

17. The system of claim 11, the operations further comprising generating an alert signal when the at least one calculated parameter is below a predetermined threshold.

18. The system of claim 11, wherein the performance standard is configured to be adjustable based on one or more of a given application of the machine, a given environmental temperature, or a given location.

19. The system of claim 11, wherein the sensor module is configured to detect the at least one control parameter at a position located before a low pass filter of the machine.

20. A method for monitoring a startup condition of a machine, the method comprising:
detecting, using a sensor, at least one control parameter of a machine;
receiving, storing, and transmitting the at least one control parameter to at least one processor;
determining, by the at least one processor, a performance standard for the machine using a physics-based model and historical data;
adjusting, by the at least one processor, the determined performance standard using a machine learning model and additional historical data to account for at least one of systemic, equipment, environmental, or geographic variations;
generating, by the at least one processor, at least one calculated parameter for the machine based on the adjusted performance standard; and
displaying, by the at least one processor via a user interface, a startup health indicating at least one startup condition of the machine based on the determined at least one calculated parameter.
